(19) United States
(12) Patent Application Publication
(10) Pub. No.: US 2005/0201727 A1
(43) Pub. Date: Sep. 15, 2005

(54) Writing/reading control method of HD stream

(75) Inventors: Hyun Sang Park, Seoul (KR); Woo Hyun Paik, Yongin-si (KR); Jong Seok Park, Goonpo-si (KR); Kang Suk Chai, Seoul (KR); Ssang Soo Lee, Suwon-si (KR); Jong Won Lim, Anyang-si (KR); Hyung Jin Kim, Seoul (KR); Il Gun Kwon, Seoul (KR); Bo Sung Kim, Incheon-si (KR)

Correspondence Address: BIRCH STEWART KOLASCH & BIRCH, PO BOX 747, FALLS CHURCH, VA, 22040-0747, US

(73) Assignee: LG Electronics Inc.

(21) Appl. No.: 11/076,864

(22) Filed: Mar. 11, 2005

(30) Foreign Application Priority Data
Mar. 12, 2004 (KR) 16806/2004

(51) Int. Cl. H04N 5/76; H04N 5/781

(52) U.S. Cl. 386/94; 386/123; 386/125

(57) ABSTRACT

The present invention provides a writing/reading control method of HD stream. The present invention buffers an HD stream in an HDD, transfers the buffered HD stream to a DVD module to record the stream in a DVD medium, and reads the record stream. The present invention includes the steps of receiving an HD digital broadcast signal to demodulate into an HD stream in a PVR module, buffering the demodulated HD stream in an HDD, transferring the buffered HD stream to a DVD module to record the transferred HD stream in a DVD medium, reading the HD stream recorded in the DVD medium, buffering the read HD stream in the HDD, and decoding to read the read HD stream buffered in the HDD.

### BACKGROUND OF THE INVENTION

1. Field of the Invention

The present invention relates to a writing/reading control method of HD Stream, by which HD (High Definition) streams can be wrote/read in/from a DVD medium.

2. Discussion of the Related Art

Generally, a digital broadcast receiver is capable of reading a received data stream that has been stored therein or enabling real-time storage and read of the received data stream. Such a digital broadcast receiver is shown in FIG. 1.

FIG. 1 is a block diagram of a digital broadcast receiver according to a related art.

Referring to FIG. 1, a digital broadcast receiver consists of a tuner/demodulator 2 receiving a broadcast signal from a prescribed service medium to output digital data, a stream controller 4 adjusting a transport path of a data stream from the tuner/demodulator 2, a DEMUX/MPEG (demultiplexer/Moving Pictures Experts Group) decoder 6 connected to an output end of the stream controller 4, an MPEG memory 8 connected to the DEMUX/MPEG decoder 6, RAM/CPU/ROM/user interface 12/14/16/18 connected to a system bus 10 in common, and a hard disc drive (HDD) 20 storing the data stream therein.

An operation of the digital broadcast receiver is explained as follows.

First of all, the tuner/demodulator 2 receives a broadcast signal transmitted from a service medium via an input line 1 and then converts the received broadcast signal to a digital data stream to output.

By a control of the CPU 14, the stream controller 4 stores the data stream outputted from the tuner/demodulator 2 in the HDD 20 or outputs the data stream to the DEMUX/MPEG decoder 6 for reading. And, the stream controller 4 reads the data stream stored in the HDD 20 via the DEMUX/MPEG decoder 6.

By a control of the CPU 14, the DEMUX/MPEG decoder 6 selects the data stream inputted from the stream controller 4, temporarily stores the selected data stream in the MPEG memory 8, reads the stored data stream to decode by MPEG, and then outputs the decoded data stream via an output line 7.

The CPU 14 controls communications of the respective units or elements via the system bus 10 and performs a control operation corresponding to a user command inputted from the user interface 18. For instance, the CPU 14 changes a receiving channel of the tuner/demodulator 2 according to a user command and also changes a receiving path of the data stream in the stream controller 4.

And, the RAM (random access memory) 12 and the ROM (read only memory) 16 are used in the control operation of the CPU 14.

Thus, the related art digital broadcast receiver stores the received data stream to read or reads and stores the received data stream simultaneously, using the HDD 20. In this case, even if the received data stream generally includes several broadcast programs, a user does not view the several broadcast programs simultaneously but selects to view a specific broadcast program only.

Various digital product groups are developed and marketed as digital broadcasting has lately been put to practical use. And, products equipped with PVR (personal video recorder) function come into the market.

Since a conventional DVD-RW (digital versatile or video disc-RW) apparatus stores broadcast streams by PS (program streaming) format or stores analog outputs of decoded HD streams, it is impossible to store/read HD real-time broadcast streams without degradation of image quality.

Namely, the related art DVD, which can store the video streams, is DVD-Video or DVD-VR (video recorder) that can store SD (standard definition) streams only. In this case, the related art DVD has a capacity of about two-hour storage of DVD image quality.

However, in the related art DVD, the DVD medium can store not the currently broadcasted HD video streams but the SD video streams. Hence, the demand for storing HD video streams in DVD perpetually despite the reduction of reading time is rising.

### SUMMARY OF THE INVENTION

Accordingly, the present invention is directed to a Writing/Reading control method of HD stream that substantially obviates one or more problems due to limitations and disadvantages of the related art.

A first object of the present invention is to provide a Writing/Reading control method of HD stream, by which an HD stream can be stored in a DVD medium.

A second object of the present invention is to provide a Writing/Reading control method of HD Stream, by which an HD stream stored in a DVD medium can be read.

A third object of the present invention is to provide a Writing/Reading control method of HD stream, by which an HD broadcast stream is recorded in a DVD medium by real time and by which HD stream data stored in the DVD medium can be read by real time.

A fourth object of the present invention is to provide a Writing/Reading control method of HD stream, by which contents protection is achieved by performing encryption, record, decryption, and reading on a transport stream.

A fifth object of the present invention is to provide a Writing/Reading control method of HD stream, by which stable data transmission/reception can be implemented by performing data buffering in HDD in writing/reading an HD stream in/from a DVD medium.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a writing control method of HD stream according to the present invention includes the steps of demodulating an HD stream from a received digital broadcast signal, storing the demodulated HD stream in an HDD, transferring the stored HD stream to a DVD module, and recording the HD stream transferred from the DVD module in a DVD medium.

In another aspect of the present invention, a Reading control method of HD stream includes the steps of reading to store HD stream data recorded in a DVD medium temporarily, reading the temporarily stored HD stream data to store in an HDD, and decoding to read a transport stream stored in the HDD by a video decoder.

In another aspect of the present invention, a writing/reading control method of HD stream includes the steps of receiving an HD digital broadcast signal to demodulate into an HD stream in a PVR module, buffering the demodulated HD stream in an HDD, transferring the buffered HD stream to a DVD module to record the transferred HD stream in a DVD medium, reading the HD stream recorded in the DVD medium, buffering the read HD stream in the HDD, and decoding to read the read HD stream buffered in the HDD.

Therefore, the present invention is characterized in buffering an HD broadcast signal in an HDD, storing the buffered signal in a DVD medium, and reading HD stream data stored in the DVD medium.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a block diagram of a digital broadcast receiver according to a related art;

FIG. 2 is a block diagram of a writing/reading system of HD stream according to one embodiment of the present invention;

FIG. 3 and FIG. 4 are block diagrams for a signal flow according to a data writing path to a DVD medium of the present invention;

FIG. 5 and FIG. 6 are block diagrams for a signal flow according to a data reading path from a DVD medium of the present invention;

FIG. 7 is a flowchart of a writing/reading control method of HD stream according to an embodiment of the present invention; and

FIG. 8 is a flowchart of a reading control method of HD stream according to an embodiment of the present invention.

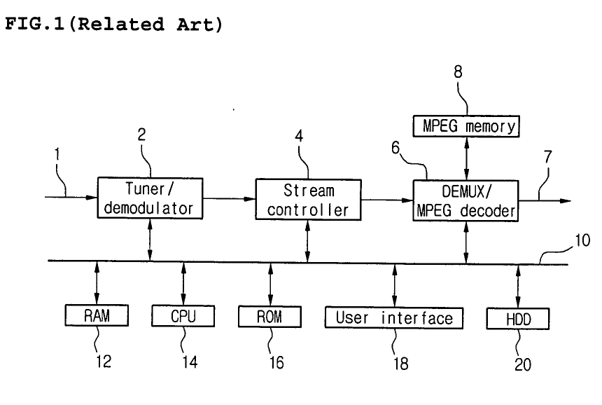

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

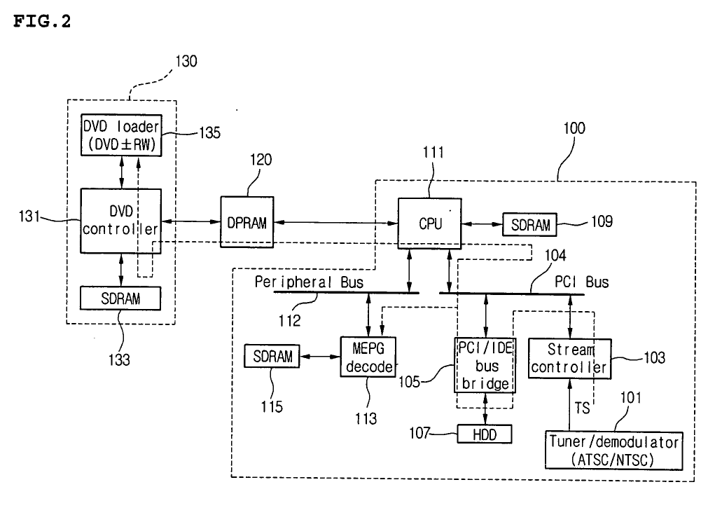

First of all, a writing/reading system of HD stream according to the present invention is explained with reference to FIG. 2 as follows.

FIG. 2 is a block diagram of a writing/reading system of HD stream of the present invention.

Referring to FIG. 2, a writing/reading system of HD stream includes a first module 100 having a PVR (personal video recorder) function, a second module 130 for writing/reading in/from a DVD medium, and an interface unit 120 connecting the first and second modules 100 and 130.

The first module 100 includes a tuner/demodulator 101 for channel selection and demodulation of a digital broadcast signal, a transport stream (TS) controller 103 transferring the demodulated transport stream as an encryption transport stream (ETS), a bus bridge unit 105 connected to a system bus, an HDD 107 for buffering the transport stream transferred via the bus bridge unit 105, a system memory 109 for temporarily storing the transport stream, a central processor unit 111 controlling the respective elements via the system bus, and an MPEG decoder 113 reading the transport stream, and a video memory 115 for temporary storage on stream reading.

The second module 130 includes a DVD controller 131 for controlling a DVD loader (DVD±RW) 135 and a DVD memory 133 temporarily storing data writing/reading in/from the DVD medium by the DVD controller 131.

Preferably, each of the system memory 109, the video memory 115, and the DVD memory 133 includes an SDRAM (synchronous dynamic random access memory). The interface unit 120 preferably includes a DPRAM (dual-port RAM). The bus bridge unit 105 preferably includes a PCI/IDE Bus bridge. And, the system bus preferably includes a PCI (peripheral component interconnect) bus.

The above-configured writing/reading system and control method thereof are explained with reference to the attached drawing as follows.

Referring to FIG. 2, the first and second modules 100 and 130 have the composite configuration. The first and second modules 100 and 130 are connected together by the interface unit 120 to transmit/receive data mutually. The composite device is operative as a DVD recorder having an HDD.

The first module 100 is a PVR module, the second module 130 is a DVD-RW (digital video or versatile disc-rewritable) module, and the interface unit 130 preferably includes DPRAM.

The tuner/demodulator 101 receives a broadcast signal via channel selection of HD digital broadcast signal and converts the received broadcast signal to digital transport stream (TS) to output.

The stream controller 103, which is connected to the system bus (PCI BUS), performs PID (packet ID) filtering of the demodulated transport stream under the control of the CPU 111 and encryption for copy prevention to accumulate the encrypted data at an internal buffer. In doing so, the encryption is not performed in real-time reading mode or encryption function stop mode.

The CPU 111 reads a predetermined quantity of stream data via the system bus 104, stores the data in the system memory 109 temporarily, and reads the stored data again to store in the HDD 107 via the bus bridge unit 105 connected to the PCI bus 104.

Since the transport stream is encrypted by the stream controller 103, contents protection for the HD stream can be provided without a separate encryption process. And, the stream data stored in the HDD 107 are stored as source data for the transport to the second module 130.

As the HD stream of terrestrial wave follows the transport stream (TS) format, buffering is needed to store the transport stream format in the DVD medium in direct. In this case, the HDD 107 is used as a buffering means. In case of being stored in the HDD 107, the transport stream format is stored in the formats of 4-byte timestamp and TS 188-byte encryption.

The HD stream stored in the HDD 107 enables real-time reading via the video decoder 113. The HD stream stored in the HDD 107 can be stored as an individual broadcast program within the capacity of the HDD 107. If one broadcast program is attempted to be stored in the HDD 107 that is out of capacity, a specific broadcast program that was previously stored is erased. If a user selects ‘DVD copy’ through a record list stored in the HDD, it is able to copy the corresponding broadcast program to the DVD medium.

Thus, a user attempts to write/read the HD stream, which is wrote in the HDD 107, in/from the DVD medium. For this, the CPU 111 transfers control data, which is controlled match with an interface state with the second module 130, to the DVD controller 131 of the second module 130 to record the HD stream, which is stored in the HDD 107, in another disc. Namely, the CPU 111 transfers the control data to provide an enabled state of data transfer.

Subsequently, the CPU 111 temporarily stores the stream data stored in the HDD 107 and then hands a control authority over to the DVD controller 131 of the second module 130. In doing so, the DVD controller 131 of the second module 130 reads the stream data stored in the system memory 109 of the first module 100 via the interface unit 120 and then stores the read data in the DVD memory 133 of the second module 130.

The DVD controller 131 of the second module 130 record the stream data stored in the DVD memory 133 by a predetermined speed in the DVD medium using the DVD loader (DVD±RW) 135. In this case, the data recorded in the DVD medium are the encrypted stream data of which copy is prevented.

In case of recording the HD stream in the DVD medium, information of the program is stored together. Since there exists a copy state flag of the program, it is able to put in the information of ‘Copy Never’, ‘Copy Once’ and the like.

Moreover, in the DVD medium, prescribed information is recorded to identify that HD stream is stored therein. Namely, the DVD medium is divided into record information, reading information, and data areas of the HD stream. A title, language, time, file size and the like of the HD stream are recorded in the record information area. And, reading address, equipment information and the like are included in the reading information area.

The interface unit 130 connecting the first and second modules 100 and 130 together includes a DPRAM. The interface unit 130 minimizes a transport time of the data transferred between the first and second modules 100 and 130 via buffering and enables real-time data transmission/reception.

For fast data transport between two processors (CPU, DVD controller), the interface unit 130 divides a dual port RAM area into two channels to use as a data transport channel and a data transport control channel, respectively. Separate transport protocol data is not added in the data transport channel to increase data transport efficiency. Instead, size information by block unit is included to be transferred. And, data transport channel control information is transmitted over the data transport control channel.

Meanwhile, the HD stream stored in the DVD medium of the second module 130 is read in a reverse sequence of the above-explained one. Namely, the DVD controller 131 of the second module 130 stores the data, which is temporarily stored in the DVD memory 133 and is stored in the DVD memory 133 by the CPU 111, in the system memory 109, stores them in the HDD 107. The data are decrypted by the stream controller 103. And, the decrypted data are decoded by the MPEG decoder 113 to be read.

The usable authority of the DPRAM as the interface unit connecting the PVR and DVD modules is given to the DPU 111 of the PVR module or the DVD controller 131 of the DVD-RW module according to whether the system is in reading or writing mode.

As another embodiment, the received transport stream data is stored in the HDD 107, and simultaneously, can proceed to the MPEG decoder 113 in a mode enabling real-time reading. In this mode, the encryption process of the stream controller is skipped.

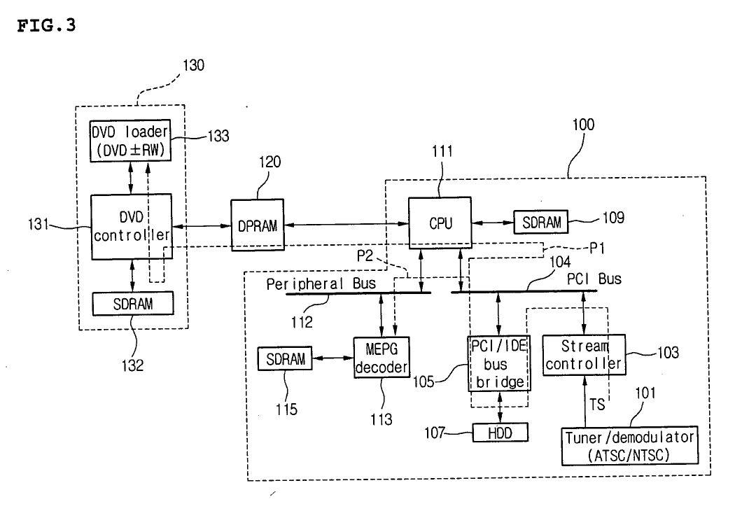

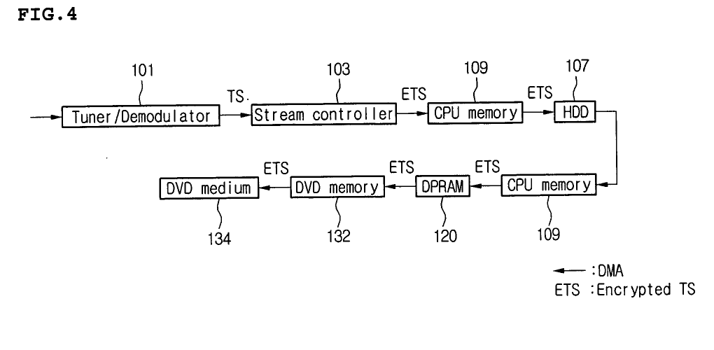

A record sequence of an HD stream according to the present invention is shown in FIG. 3 and FIG. 4, which is explained as follows.

First of all, a digital broadcast signal is converted to a transport stream (TS) by the tuner/demodulator 101 and is then outputted as an encrypted transport stream by the stream controller 103. By the CPU 111, the encrypted transport stream is primarily buffered in the HDD 107 via the system (CPU) memory 109. And, a predetermined size of the stream data stored in the HDD 107 is read in to the system memory 109.

In doing so, the DVD controller 131 of the second module 130 reads the data stored in the system memory 109 of the first module 100 via the interface unit (DPRAM) 120 and then temporarily stores the read data in the DVD memory 133. And, the DVD controller 131 records the data of the DVD memory 133 in the DVD medium via the DVD loader 135. In this case, DMA (direct memory access) is used for the data transfer between the memories.

The transport stream, as shown in FIG. 3, is recorded in the DVD medium while being stored in the HDD via a first path P1 or is read via the video decoder 113 while being stored in the HDD via a second path P2.

In doing so, a record operation in the DVD medium is to record initial reading information in the DVD medium for the reading of the HD stream. Namely, the DVD medium is divided into record information, reading information, and data areas of the HD stream. A title, language, time, file size and the like of the HD stream are recorded in the record information area. And, reading address, equipment information and the like are included in the reading information area.

In case that a user attempts to record a specific program in the DVD medium after a duration of prescribed time while broadcast programs are stored in the HDD, the path follows a process of reading to store the stream data of the HDD 107 in the system memory 109 and transferring the data to the second module.

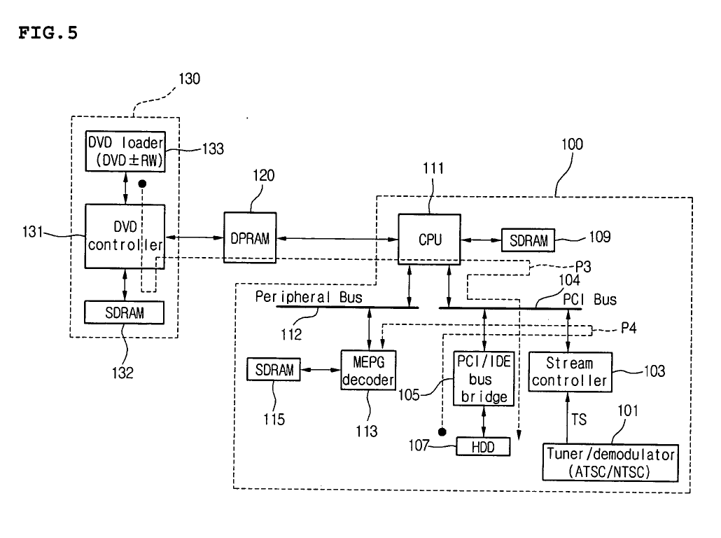

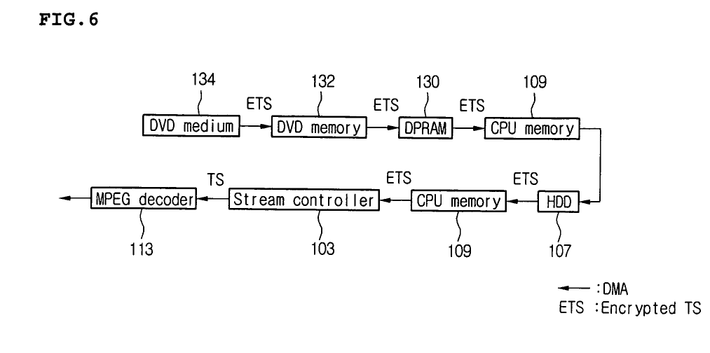

FIG. 5 and FIG. 6 are block diagrams for a signal flow according to a data read path from a DVD medium of the present invention.

Referring to FIG. 5 and FIG. 6, the DVD controller 131 reads initial reading information and data recorded in the DVD medium via the DVD loader and then stores them in the DVD memory 133 by a predetermined size.

The CPU 111 of the first module 100 stores the data of the DVD memory 133 in the system memory 109 via the interface unit (DPRAM) 120 and then stores them in the HDD 107 again. The data stored in the HDD 107 are temporarily stored in the system memory 109 and is then decrypted by the stream controller 103. The decrypted stream is decoded by the MPEG decoder 113 to perform image playback. In doing so, the MPEG decoder 113 temporarily stores the transport stream in the SDRAM 115 for video play.

The HD stream data recorded in the DVD medium follow a storage path P3 in the HDD and a reading path P4 that the data are stored in the HDD to be decrypted.

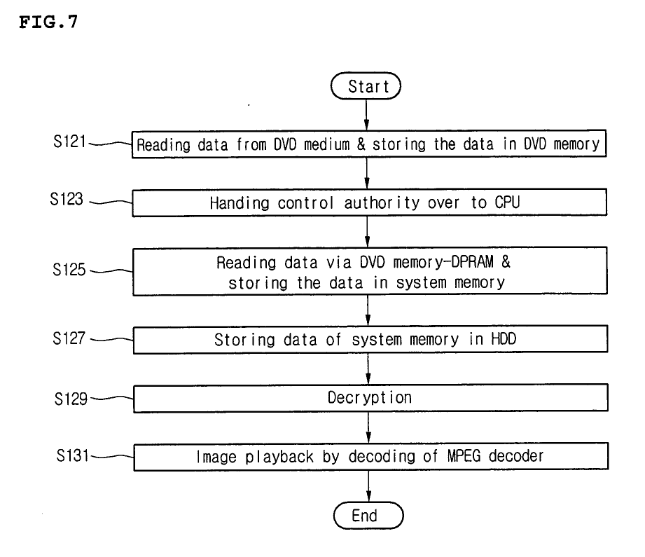

FIG. 7 is a flowchart of an HD stream record control method according to an embodiment of the present invention.

Referring to FIG. 7, if a broad cast signal received by a tuner/demodulator is demodulated into a transport stream (S101), a stream controller performs PID filtering and encryption and then stores the encrypted transport stream in an internal buffer (S103). Once the stored stream forms a predetermined quantity of stream data, a CPU reads the stream data to store in a system memory and then transfers the data to an HDD to store therein (S105, S107).

Subsequently, the CPU transfers control data to a DVD controller (S109). And, the DVD controller sustains its standby state. After having read the prescribed quantity of the stream data stored in the HDD to store in the system memory, the CPU hands a control authority over to the DVD controller (S11, S113). The DVD controller reads the stream data via the system memory and an interface unit (DPRAM), stores the read data in a DVD memory, and then records the data in a DVD medium using a DVD loader (S115, S117).

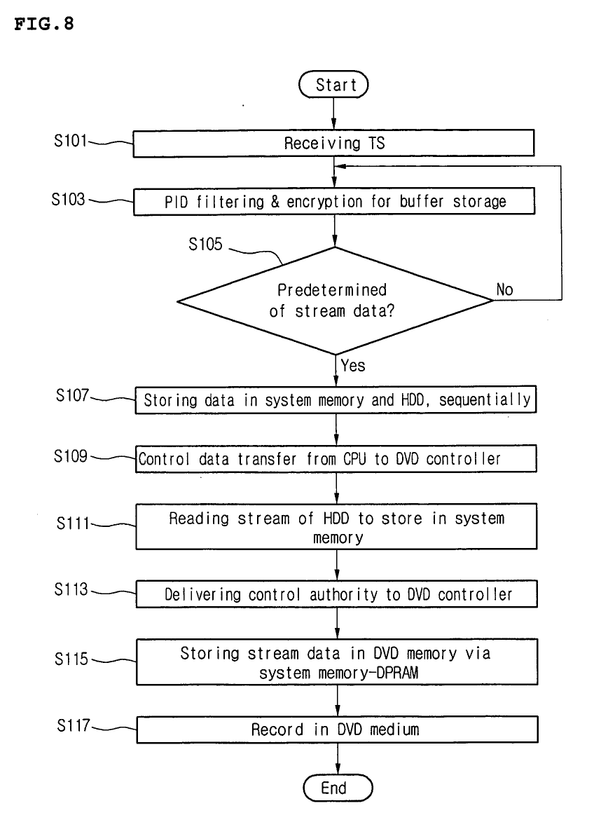

FIG. 8 is a flowchart of a reading control method of HD stream according to an embodiment of the present invention.

Referring to FIG. 8, a DVD module reads data recorded in a DVD medium via a DVD loader and then stores the read data in a DVD memory (S121) and then hands a control authority over to a CPU of a PVR module (S123). The CPU reads the data via an interface unit (DPRAM) and a DVD memory to store in a system memory primarily and then moves the data to an HDD to store therein (S125, S127).

Subsequently, the CPU transfers the data stored in the HDD to a stream controller. The stream controller decrypts the data. And, an MPEG decoder decodes the decrypted data to display on a screen (S129, S131).

Thus, the writing/reading system of HD stream records the transport stream data received by the broadcast receiver such as a PVR module in the disc medium of another DVD module and reads the recorded transport stream to read. And, the system provides the means for fast transmission/reception of the transport stream data between the PVR and DVD-RW modules, thereby minimizing the delay time due to buffering and thereby securing real-time data transport.

Moreover, the system can provide the mutual transmission/reception of other media formats (MP3, JPEG) between the DVD-RW and PVR modules via fast data transport paths as well as the mutual transmission/reception of the HD stream.

As mentioned in the foregoing description of the writing/reading method of HD stream according to the present invention, the HD broadcast stream is wrote/read in/from the external disc medium by real time, whereby the storage limit of the conventional DVD-RW is overcome and whereby stable data transmission/reception via the buffering using the HDD is enabled.

Moreover, the present invention enables fast data transmission/reception with the DVD-RW module using the DPRAM, thereby minimizing the delay time due to buffering and thereby securing real-time data transport.

It will be apparent to those skilled in the art that various modifications and variations can be made in the present invention. Thus, it is intended that the present invention covers the modifications and variations of this invention provided they come within the scope of the appended claims and their equivalents.

1. An HD stream record control method comprising the steps of:
demodulating an HD stream from a received digital broadcast signal;
storing the demodulated HD stream in an HDD;
transferring the stored HD stream to a DVD module; and
recording the HD stream transferred from the DVD module in a DVD medium.

2. The HD stream record control method of claim 1, wherein the stream recorded in the HDD and the DVD medium are encrypted.

3. The HD stream record control method of claim 1, wherein whether to encrypt the HD stream stored in the HDD is decided prior to storage.

4. The HD stream record control method of claim 1, wherein the HD stream stored in the HDD is transferred to the DVD module via a dual port memory.

5. The HD stream record control method of claim 1, wherein the DVD medium includes a record information area including a title, language, time, file size of the HD stream, a reading information area including a reading address and device information, and a data area having data recorded therein.

6. The HD stream record control method of claim 1, wherein copy preventing information is recorded together in recording the HD stream in the DVD medium.

7. The HD stream record control method of claim 1, wherein the HD stream stored in the HDD is recorded in the DVD medium by real time.

8. The HD stream record control method of claim 1, wherein the HD stream is recorded in the DVD medium after having been buffered in the HDD.

9. A reading control method of HD stream comprising the steps of:
reading to store HD stream data recorded in a DVD medium temporarily;
reading the temporarily stored HD stream data to store in an HDD; and
decoding to read a transport stream stored in the HDD by a video decoder.

10. The reading control method of HD stream of claim 9, further comprising the steps of:
checking whether the HD stream data recorded in the DVD medium are encrypted; and
if the HD stream data are encrypted, performing decryption prior to read.

11. The reading control method of HD stream of claim 9, wherein the HD stream data read from the DVD medium are buffered in the HDD by frame unit.

12. The reading control method of HD stream of claim 10, further comprising the step of if the HD stream data stored in the HDD is an encrypted stream, decrypting the stream to output to the video decoder.

13. A writing/reading control method of HD stream comprising the steps of:
receiving an HD digital broadcast signal to demodulate into an HD stream in a PVR module;
buffering the demodulated HD stream in an HDD;
transferring the buffered HD stream to a DVD module to record the transferred HD stream in a DVD medium;
reading the HD stream recorded in the DVD medium;
buffering the read HD stream in the HDD; and
decoding to read the read HD stream buffered in the HDD.

14. The writing/reading control method of HD stream of claim 13, wherein the HD stream is encrypted prior to being buffered in the HDD.

15. The writing/reading control method of HD stream of claim 13, wherein the HD stream is decrypted prior to being decoded.

16. The writing/reading control method of HD stream of claim 13, wherein the HD stream is transmitted/received by a stream data unit of a predetermined quantity.

17. The writing/reading control method of HD stream of claim 13, wherein the DVD module interfaces DPRAM.
